(19) United States
(12) Patent Application Publication
(10) Pub. No.: US 2014/0242843 A1
(43) Pub. Date: Aug. 28, 2014

(54) SIGNAL TRANSMISSION APPARATUS OF CONNECTOR

(71) Applicant: YA-HUI HUANG, New Taipei City (TW)

(72) Inventor: YA-HUI HUANG, New Taipei City (TW)

(21) Appl. No.: 13/775,103

(22) Filed: Feb. 22, 2013

(51) Int. Cl. H01R 13/66

(52) U.S. Cl. CPC H01R 13/6658
USPC 439/620.23

(57) ABSTRACT

The present invention related to a signal transmission apparatus of connector that includes a substrate on which multiple signal transmitters are disposed. Each of the signal transmitters is made of at least a capacitor or an inductor and disposed on the substrate by surface mount technology (SMT). The substrate further includes multiple winding coils that are electrically connected to the corresponding signal transmitters individually. The substrate, signal transmitters and winding coils are disposed within a RJ connector. The manufacture of the present invention only requires to dispose the signal transmitters on the substrate by SMT and electrically connect the winding coils to the corresponding signal transmitters so as to achieve the enhancement of the electrical characteristics (RL or IL), stable product quality and increase of production through-put as well as further improve the character of common mode rejection mode (CMRR).

### TECHNICAL OF THE INVENTION

The present invention relates to a signal transmission apparatus, and particularly to a signal transmission apparatus of connector for enhancing the electrical characteristics, stabilizing the product quality and increasing the production through-put along with further improving the character of common mode rejection ratio.

### DESCRIPTION OF THE PRIOR ART

Application of connectors is of broad range such as RJ connector, USB connector and HDMI connector that employs the technique to connect the signals at both ends of a connector and extends from the original application on computers to the recent one on television. However, the manufacture of the connectors usually requires relatively longer time resulting in a limited quantity produced within a predetermined time-frame. Taking the most frequently used RJ connector as required in every house today for example, the connector contains multiple signal transmitters and each signal transmitter is made of multiple coils winded on a conducting wire. The function of the signal transmitter is literally to convert a signal into a voltage but the relatively longer production time and unstable product quality caused by the aforesaid manufacture of winding multiple coils onto a conducting wire result in the ineffective promotion for industrial competition.

### SUMMARY OF THE INVENTION

Thus, an objective of the present invention is to provide a signal transmission apparatus of connector with the enhanced electrical characteristics (Return Loss, RL or Insertion Loss, IL), stable product quality and increased production through-put as well as the improvement on the character of common rejection ratio and effective reduction of electromagnetic interference (EMI).

One other objective of the present invention is to utilize the surface mount technology (SMT) for assembly in order to save the production manpower, shorten the production time and thus increase the production through-put.

Another objective of the present invention is to utilize SMT for assembly in order to replace the traditional manufacture means of hand-winding in order to enhance the product quality and production yield rate.

In order to achieve the aforesaid objectives, the present invention is to be disposed within a RJ connector and the main structure of the present invention includes a substrate on which multiple signal transmitters are disposed. Each of the multiple signal transmitters is made of at least a capacitor or an inductor as disposed by SMT on the substrate that further includes multiple winding coils that are electrically connected to the corresponding signal transmitters individually. Thus the manufacture of the present invention only requires the direct employment of SMT to dispose the signal transmitters, each of which is made of at least a capacitor or an inductor, on the substrate and then apply the electrical connection from the signal transmitters to the corresponding winding coils so as to complete the present invention. According to the aforesaid technique, the difficulties of long production time and unstable product quality of the prior art are resolved specifically by the elimination of winding coils onto a conducting wire so as to achieve the aforesaid advantages of the present invention.

### BRIEF DESCRIPTION OF THE DRAWINGS

FIG. 1 is a systematic block diagram illustrating a preferred embodiment of the present invention.

FIG. 2 is a schematic block diagram illustrating a preferred embodiment of the present invention.

FIG. 3 is a schematic view illustrating the application of a preferred embodiment of the present invention.

### DETAILED DESCRIPTION OF THE PREFERRED EMBODIMENTS

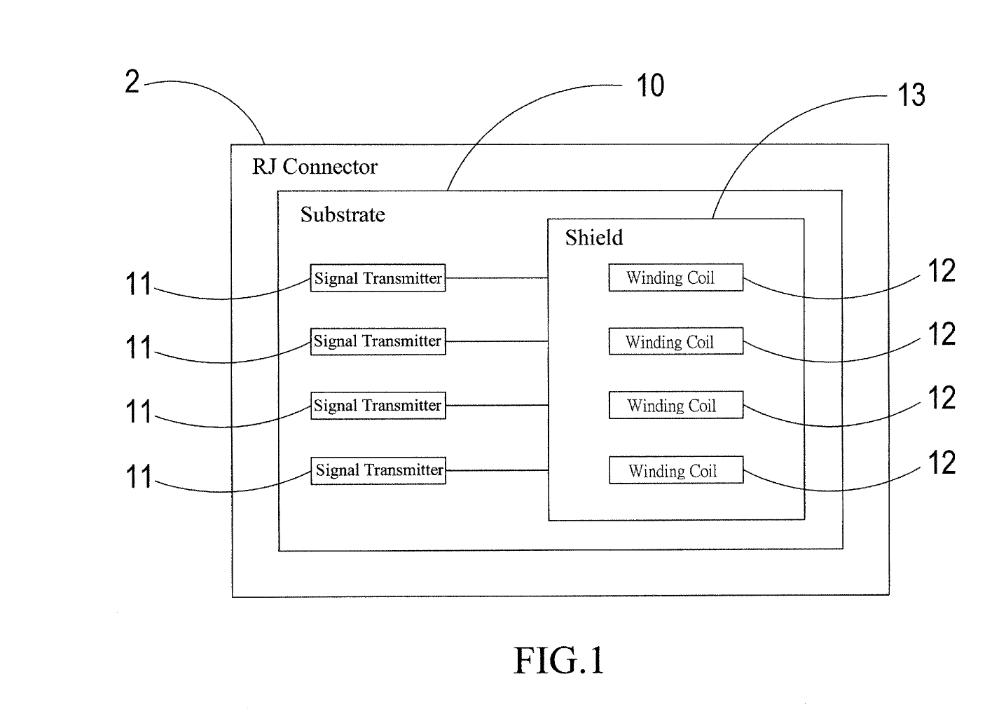

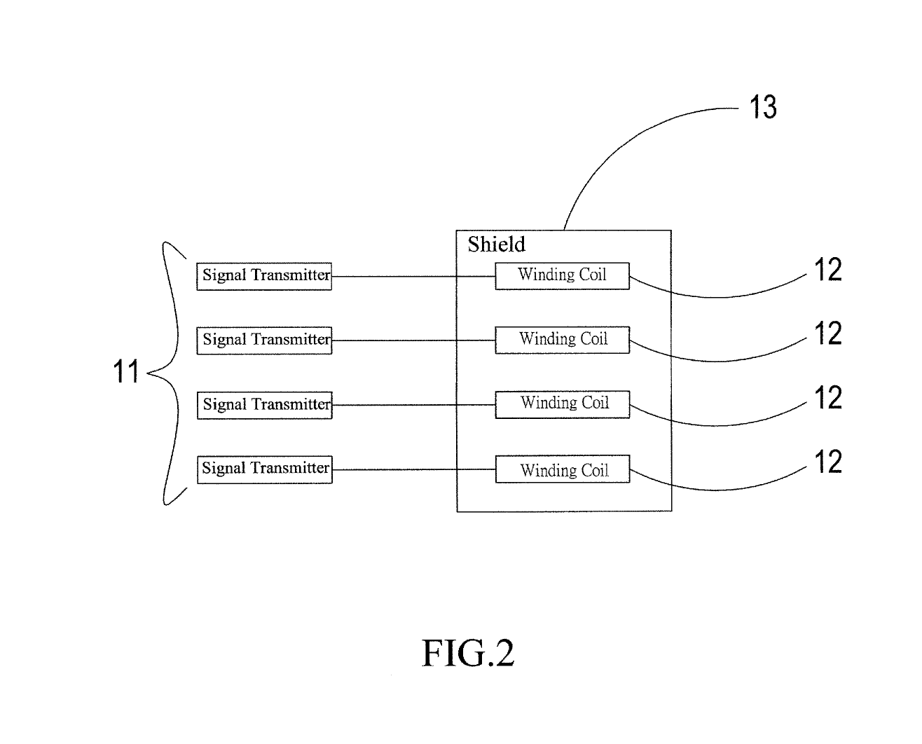

The preferred embodiments of the present invention will be illustrated with reference to FIG. 1 and FIG. 2, a systematic block diagram and a schematic block diagram illustrating a preferred embodiment of the present invention respectively. FIG. 1 and FIG. 2 clearly depict the signal transmission apparatus of connector of the present invention that is disposed within a RJ connector 2. The signal transmission apparatus primarily includes: a substrate 10, which is a PCB substrate; multiple signal transmitters 11, each of which is made of at least a capacitor or an inductor and further includes at least a resistor, as disposed on the substrate 10 by surface mount technology (SMT); multiple winding coils 12, which are masked by a shield 13, as disposed on the substrate 10 and electrically connected to the corresponding signal transmitters 11 individually whereby the inductance of the signal transmitters is utilized to isolate noise and transmit signals as well as further improve the character of common mode rejection ratio (CMRR) and effectively reduce the electromagnetic interference (EMI) together with the enhancement for both stable product quality and increased production yield rate.

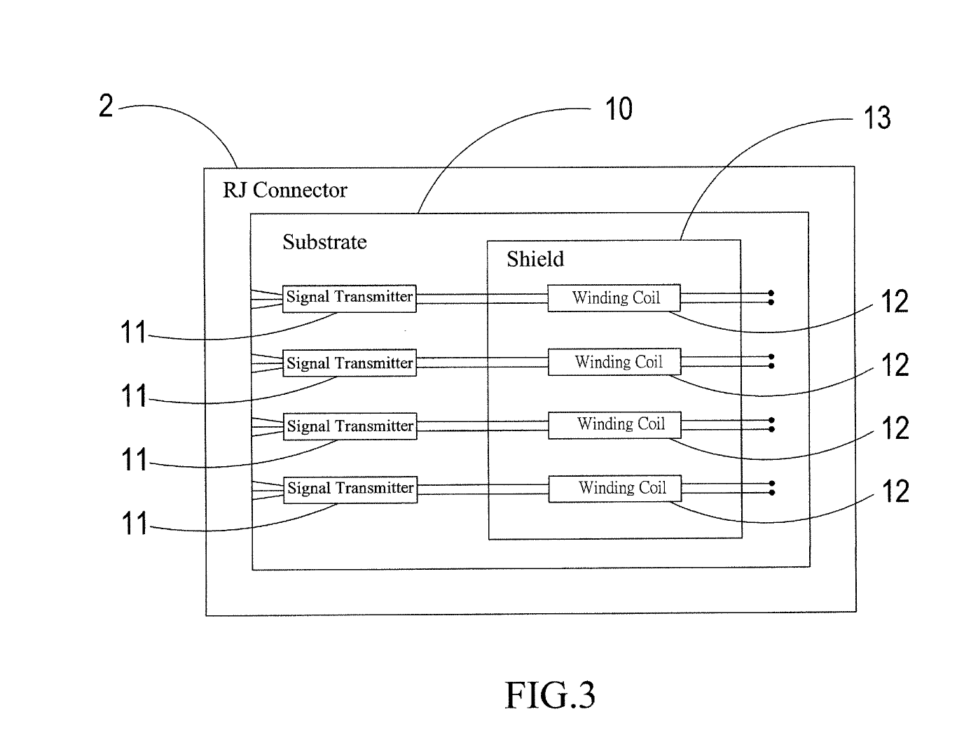

Hereby the operation of the present invention is disclosed according to the aforesaid structure and design with reference to FIG. 1, FIG. 2 and FIG. 3, which are the systematic block diagram, the schematic block diagram and schematic view illustrating a preferred embodiment of the present invention respectively, as follows. The figures clearly show that the manufacture of the signal transmission apparatus of the RJ connector 2 is completed by directly taking the substrate 10, disposing the signal transmitters 11, each of which is made of at least a capacitor or a conductor, on the substrate 10 by surface mount technology (SMT) and then electrically connecting the signal transmitters 11 to the corresponding winding coils 12 individually. Thus the RJ connector 2 achieves the objective of enhancing the electrical characteristics (RL or IL) and improving the character of common mode rejection ratio. Further, the winding coils 12 are masked by the shield 13 as a module so as to achieve the objectives of stabilizing the product quality and enhancing the production yield rate as well as saving the production manpower, shortening the production time and increasing the production through-put.

As explained above with reference to FIG. 1 to FIG. 3, the present invention is advantageous over the prior art with specific novelties of:

1. enhancing the electrical characteristic (RL or IL),

2. improving the character of CMRR,

3. effectively reducing EMI,

4. saving the production manpower, shortening the production time and increasing the production through-put, and

5. enhancing the production yield rate by stabilizing the product quality.

I claim:

1. A signal transmission apparatus of connector being disposed within a RJ connector, the signal transmission apparatus comprising:
a substrate;
a plurality of signal transmitters being individually disposed on said substrate and each of said signal transmitters being made of at least a capacitor or an inductor disposed on said substrate by surface mount technology; and,
a plurality of winding coils being disposed on said substrate and electrically connected to said signal transmitters correspondingly wherein
the inductance of said signal transmitters is utilized to isolate noise and transmits signals.

2. The signal transmission apparatus of connector of claim 1, wherein said substrate is a PCB substrate.

3. The signal transmission apparatus of connector of claim 1, wherein each of said signal transmitters further includes at least a resistor.

4. The signal transmission apparatus of connector of claim 1, wherein the signal transmission apparatus further includes a shield for masking said winding coils.
